(19) United States
(12) Patent Application Publication
(10) Pub. No.: US 2026/0006431 A1
(43) Pub. Date: Jan. 1, 2026

(54) DEVICE FOR REPORTING TERMINAL CAPABILITY

(71) Applicant: GUANGDONG OPPO MOBILE TELECOMMUNICATIONS CORP., LTD., Dongguan (CN)

(72) Inventor: Jinqiang XING, Dongguan (CN)

(21) Appl. No.: 19/321,512

(22) Filed: Sep. 8, 2025

Related U.S. Application Data
(63) Continuation of application No. PCT/CN2023/086294, filed on Apr. 4, 2023.

(51) Int. Cl. H04W 8/22; H04W 52/24; H04W 52/36; H04W 76/15; H04W 76/20

(52) U.S. Cl. CPC H04W 8/22; H04W 52/243; H04W 52/367; H04W 76/15; H04W 76/20

(57) ABSTRACT

Provided are a terminal device and a network device. The terminal device includes N subscriber identity modules (SIMs), N being greater than 1. The terminal device includes a processor and a transceiver communicably connected to the processor; where the transceiver is configured to transmit terminal capability information for a first band combination to a network device. The first band combination includes operating bands for simultaneous operation of at least two SIMs in the N SIMs.

### CROSS-REFERENCE TO RELATED APPLICATION

The present disclosure is a continuation application of International Application No. PCT/CN2023/086294 filed on Apr. 4, 2023, the entire contents of which are incorporated herein by reference.

### TECHNICAL FIELD

The present disclosure relates to the field of wireless communications, and in particular, relates to a terminal device and a network device for reporting terminal capabilities.

### RELATED ART

Multi-SIM terminal devices refer to terminal devices, for example, user equipments (UEs) equipped with a plurality of subscriber identity modules (SIMs).

Some multi-SIM terminal devices support multi-standby multi-active functionality where a plurality of SIMs are capable of simultaneously operating in a standby mode and in an active communication connection. Due to hardware limitations of the terminal device, communication capabilities of some SIMs may degrade in a case where the terminal device operates in the multi-standby multi-active state.

### SUMMARY

Embodiments of the present disclosure provide a terminal device and a network device for reporting terminal capabilities, enabling a terminal device to report to a network device capability information of each SIM for simultaneous operation of a plurality of SIMs, and thereby facilitating the network device to perform communication scheduling. The technical solutions are as follows.

According to some embodiments of the present disclosure, a terminal device equipped with N SIMs is provided, N being greater than 1. The terminal device includes: a processor and a transceiver communicably connected to the processor; wherein the transceiver is configured to transmit terminal capability information for a first band combination to a network device, wherein the first band combination includes operating bands for simultaneous operation of at least two SIMs in the N SIMs.

According to some embodiments of the present disclosure, a network device is provided. The network device includes: a processor and a transceiver communicably connected to the processor; wherein the transceiver is configured to receive terminal capability information for a first band combination from a terminal device, wherein the terminal device includes N SIMs, N being greater than 1, and the first band combination includes operating bands for simultaneous operation of at least two SIMs in the N SIMs.

### BRIEF DESCRIPTION OF DRAWINGS

For clearer illustration of the technical solutions according to the embodiments of the present disclosure, the drawings required in the description of the embodiments are described hereinafter briefly. Obviously, the drawings described herein are only some of the embodiments of the present disclosure. A person of ordinary skill in the art may derive other drawings based on these drawings without any creative efforts.

FIG. 1 is a schematic diagram of a terminal device according to some embodiments of the present disclosure;

FIG. 2 is a schematic diagram of a terminal device according to some embodiments of the present disclosure;

FIG. 3 is a schematic diagram of a terminal device according to some embodiments of the present disclosure;

FIG. 4 is a schematic diagram of a terminal device according to some embodiments of the present disclosure;

FIG. 5 is a schematic diagram of a communication system according to some embodiments of the present disclosure;

FIG. 6 is a flowchart of a method for reporting terminal capabilities according to some embodiments of the present disclosure;

FIG. 7 is a flowchart of a method for reporting terminal capabilities according to some embodiments of the present disclosure;

FIG. 8 is a flowchart of a method for reporting terminal capabilities according to some embodiments of the present disclosure;

FIG. 9 is a flowchart of a method for reporting terminal capabilities according to some embodiments of the present disclosure;

FIG. 10 is a flowchart of a method for reporting terminal capabilities according to some embodiments of the present disclosure;

FIG. 11 is a schematic diagram of band interference according to some embodiments of the present disclosure;

FIG. 12 is a schematic diagram of a communication system according to some embodiments of the present disclosure;

FIG. 13 is a schematic diagram of a communication system according to some embodiments of the present disclosure;

FIG. 14 is a schematic diagram of a terminal device according to some embodiments of the present disclosure;

FIG. 15 is a schematic diagram of band interference according to some embodiments of the present disclosure;

FIG. 16 is a structural block diagram of an apparatus for reporting terminal capabilities according to some embodiments of the present disclosure;

FIG. 17 is a structural block diagram of an apparatus for reporting terminal capabilities according to some embodiments of the present disclosure; and

FIG. 18 is a schematic structural diagram of a communication device according to some embodiments of the present disclosure.

### DETAILED DESCRIPTION

For clearer descriptions of the objectives, technical solutions, and advantages of the present disclosure, the embodiments of the present disclosure are described hereinafter in detail with reference to the drawings.

The embodiments of the present disclosure describe network architectures and service scenarios to more clearly illustrate the technical solutions of the embodiments of the present disclosure, which do not constitute limitations on the technical solutions provided by the embodiments of the present disclosure. A person of ordinary skill in the art may recognize that with evolution of the network architectures and emergence of new service scenarios, the technical solutions provided by the embodiments of the present disclosure are also applicable to similar technical problems.

It should be understood that “indication” mentioned in the embodiments of the present disclosure may be direct indication, indirect indication, or indication of an association relationship. For example, A indicates B which may mean that: A directly indicates B (e.g., B may be acquired via A); or that A indirectly indicates B (e.g., A indicates C, and B may be acquired via C); or that an association relationship exists between A and B.

In the description of the embodiments of the present disclosure, the term “corresponding” may indicate a direct or indirect correspondence relationship between two entities, or may also indicate an association relationship between two entities, or may indicate relationships such as a relationship between an instructor and an instructed entity, or a relationship between a configurator and a configured entity.

In the embodiments of the present disclosure, a “predefined” operation may be performed by pre-storing corresponding codes or tables in a device (such as a device including a terminal device and a network device), or may be performed by other means that may be used to indicate relevant information. The present disclosure does not impose any restrictions on specific methods for performing the predefined operation. For example, the predefined operation may be agreed in a protocol.

First, relevant terms mentioned in the present disclosure are introduced hereinafter.

### 1. Multi-SIM Terminal Device

A multi-SIM terminal device refers to a terminal device equipped with a plurality of SIMs, wherein the plurality of SIMs may belong to the same operator or different operators.

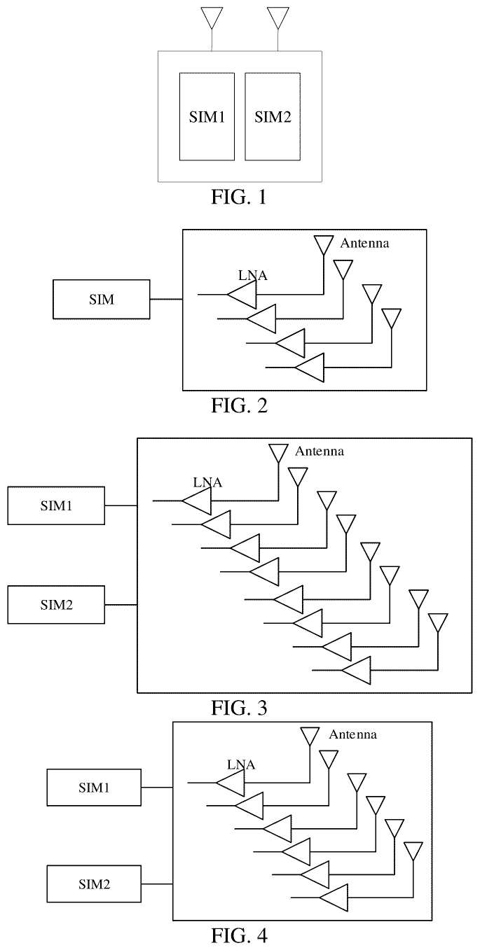

For the multi-SIM terminal device, a user may configure more than one SIM according to preferences of the user. For example, as illustrated in FIG. 1, a user may choose SIM 1 belonging to operator A for answering calls because operator A has low voice tariffs, and at the same time, the user may also choose SIM 2 belonging to operator B for data services because operator B has low data tariffs. This example constitutes a situation where a terminal device is capable of operating for different operators at the same time.

Furthermore, multi-SIM terminal devices may be classified based on whether or not these SIMs are capable of simultaneously operating.

In an example where the multi-SIM terminal device is a dual-SIM terminal device, the dual-SIM terminal device may be classified as:
a dual SIM dual standby (DSDS) terminal, where two SIMs are capable of simultaneously operating in a standby receive state, but only one of the two SIMs is capable of operating in a connected state (i.e., a transmit/receive state); and
a dual SIM active (DSA) or dual SIM dual active (DSDA) terminal, where both of the two SIMs are capable of simultaneously operating in a standby receive state and a connected state (i.e., a transmit/receive state).

A network on which each SIM of the multi-SIM terminal device operates may include a 2G/3G/4G/5G network, or the like, depending on the choice of the user.

### 2. Hardware Sharing Within a Multi-SIM Terminal Device

Generally, hardware implementation complexity and cost of the multi-SIM terminal device are higher than those of a single-SIM terminal device. Especially for a multi-SIM multi-active terminal device, the terminal device is required to support simultaneous transmission and reception for these SIMs in hardware. In some cases, exponentially more hardware resources are required for the multi-SIM terminal device to support simultaneous transmission and reception. For example, FIG. 2 illustrates a terminal device with a single SIM supporting 4-downlink reception capabilities; and FIG. 3 illustrates a terminal device with two SIMs (SIM 1 and SIM 2) supporting 4-downlink reception capabilities. When compared, the single-SIM terminal device uses 4 downlink receiving paths (including low noise amplifiers (LNAs), antennas, and the like), while the dual-SIM terminal device requires 8 downlink receiving paths, which doubles the complexity and cost.

Therefore, to reduce the hardware implementation complexity and cost, in some cases, the multi-SIM terminal device is used to reduce usage of hardware resources by lowering capabilities corresponding to a portion of a plurality of SIMs for simultaneous operation of the plurality of SIMs, to balance DSDA functionality with cost and complexity. As illustrated in FIG. 4, SIM 1 and SIM 2 share 6 downlink receiving paths. In this case, one SIM maintains full downlink receive capabilities of 4 streams, while downlink receive capabilities of another SIM is appropriately reduced to 2 streams. This implementation reduces hardware complexity.

However, this implementation has raised following problems: a difference is present between the receive capabilities of the terminal device in a single-SIM mode and the receive capabilities of the terminal device in a multi-SIM simultaneous operating mode, and this difference cannot be detected by a network device, which means that capabilities reported by the terminal device to the network are distinct from actual communication capabilities of the terminal device. The reported capabilities refer to communication capabilities of two SIMs respectively operating in a single-SIM mode. The actual communication capabilities refer to capabilities of the two SIMs operating in a dual-SIM mode. Potential problems in scheduling of the terminal device by a base station may be caused. For example, in a case where the base station performs scheduling based on the communication capabilities reported by the terminal device, the terminal device may fail to receive and demodulate data normally, resulting in a decrease in overall throughput performance.

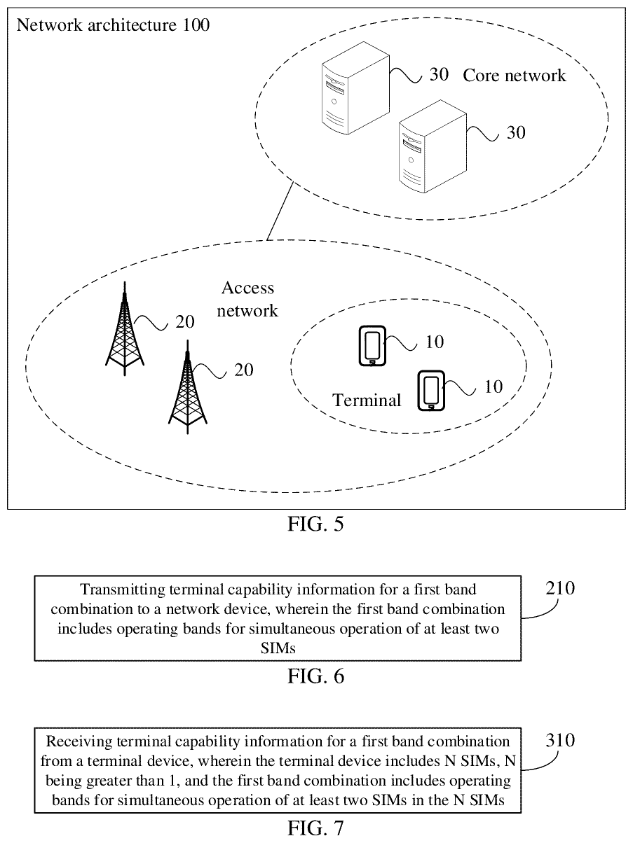

With reference to FIG. 5, FIG. 5 is a schematic diagram of a network architecture 100 according to some embodiments of the present disclosure. The network architecture 100 may involve: a terminal device 10, an access network device 20, and a core network device 30.

The terminal device 10 may refer to a UE, an access terminal device, a user unit, a user station, a mobile station, a mobile platform, a remote station, a remote terminal device, a mobile device, a wireless communication device, a user agent, or a user device. In some embodiments, the terminal device 10 may also be a cellular phone, a cordless phone, a Session Initiation Protocol (SIP) phone, a wireless local loop (WLL) station, a personal digital assistant (PDA), a handheld device with wireless communication functions, a computing device, any other processing device connected to a wireless modem, a vehicle-mounted device, a wearable device, a terminal device in a 5^{th} generation system (5GS) or a terminal device in a future evolved public land mobile network (PLMN), or the like, which are not limited in the embodiments of the present disclosure. For convenience of description, the above-mentioned devices are collectively referred to as terminal devices. Typically, a plurality of terminal devices 10 are present, and one or more of the plurality of terminal devices 10 may be distributed in a cell managed by each access network device 20.

The access network device 20 is a device deployed in an access network to provide wireless communication functions for the terminal device 10. The access network device 20 may include various forms of a macro base station, a micro base station, a relay station, an access point, or the like. In systems using different wireless access technologies, names of devices with access network device functions may be different. For example, in a 5G NR system, the device with access network device functions is referred to as a next generation node B (gNodeB or gNB) or a new generation access network node. With the evolution of communication technologies, the name “access network device” may change. For convenience of description, in the embodiments of the present disclosure, the above devices that provide wireless communication functions for the terminal device 10 are collectively referred to as access network devices. In some embodiments, a communication relationship may be established between the terminal device 10 and the core network device 30 via the access network device 20. Exemplarily, in a long-term evolution (LTE) system, the access network device 20 may be an evolved universal terrestrial radio access network (EUTRAN) or one or more eNodeBs in the EUTRAN; while in the 5G NR system, the access network device 20 may be a radio access network (RAN) or one or more gNBs in the RAN.

The access network device in a 3G communication system may be referred to as a NodeB (NB). The access network device in a 4G communication system may be referred to as an evolved NodeB (eNodeB or eNB). In a non-standalone (NSA) architecture of Option 4 series, a 4G access network device needs to be upgraded to support enterprise LTE (eLTE) and to connect to a 5G core network. The upgraded 4G access network device is referred to as an ng-eNB. The access network device in the 5G communication system is referred to as a gNB. In NAS Option3 series, since a 5G access network device needs to access a 4G core network, the 5G gNB needs to be transformed to access the 4G core network. The transformed gNB is referred to as an en-gNB.

The core network device 30 is a device deployed in the core network. Functions of the core network device 30 are mainly to provide user connection, user management, and bearer for services, and provide an interface to the external network as a bearer network. For example, the core network device in the 5G NR system may include an access and mobility management function (AMF) network element, an authentication server function (AUSF) network element, a user plane function (UPF) network element, a session management function (SMF) network element, a location management function (LMF) network element, a policy control function (PCF) network element, a unified data management (UDM) network element, or the like.

In an example, the access network device 20 and the core network device 30 communicate with each other via an interface technology, e.g., via an NG interface in the 5G NR system. The access network device 20 and the terminal device 10 communicate with each other via an air interface technology, e.g., via a Uu interface.

The access network device is an access device by which the terminal device accesses the network architecture wirelessly, and is mainly responsible for radio resource management, quality of service (QOS) management, data compression and encryption on the air interface side. For example, the access network device is the NodeB in the 3G communication system, the eNodeB in the 4G communication system, the gNB in the 5G mobile communication system or the NR communication system, or a base station in a future mobile communication system, or the like.

The “5G NR system” in the embodiments of the present disclosure may also be referred to as a 5G system or an NR system, the meaning of which may be understood by a person skilled in the art. The technical solutions described in the embodiments of the present disclosure may be applicable to an LTE system, a 5G NR system, an evolved system subsequent to the 5G NR system, or other communication systems such as a narrow-band Internet of things (NB-IoT) system, which are not limited in the present disclosure.

With reference to FIG. 6, FIG. 6 is a flowchart of a method for reporting terminal capabilities according to some embodiments of the present disclosure. The method is performed by a terminal device, and includes the following process.

In 210, the terminal device transmits terminal capability information for a first band combination to a network device, wherein the first band combination includes operating bands for simultaneous operation of at least two SIMs.

In some embodiments, the terminal device transmits the terminal capability information (also referred to as capability information) on at least one band of the first band combination. The first band combination includes an operating band on which each of the at least two SIMs operates in a case where the at least two SIMs of the terminal device simultaneously operates.

The terminal device includes at least two SIMs, or the terminal device corresponds to at least two SIMs, or the terminal device includes at least two SIMs.

In addition, the terminal device allows at least two SIMs to simultaneously operate in a connected state, or the terminal device allows at least two SIMs to simultaneously perform data communication with a network device, or the terminal device allows at least two SIMs to be simultaneously in a transmit and/or receive state, or the terminal device supports at least two SIMs.

The SIM is an integrated circuit (IC) card used to identify mobile users in a mobile communication system. The SIM may be at least one of a conventional SIM, a universal subscriber identity module (USIM), or an embedded-SIM (eSIM). The at least two SIM in the terminal device may be of the same type or different types.

The at least two SIMs may access the same network (or the same network device). For example, the terminal device establishes a connection with a first network device via SIM 1 and SIM 2, and the terminal device may communicate with the first network device via SIM 1 or SIM 2.

Alternatively, the at least two SIMs may access different networks (or different network devices). For example, the terminal device establishes a connection with a first network device via SIM 1, and the terminal device may communicate with the first network device via SIM 1; and the terminal device establishes a connection with a second network device via SIM 2, and the terminal device may communicate with the second network device via SIM 2.

Based on the above embodiments, in process 210, the terminal device may transmit the terminal capability information for the first band combination to the network device via at least one SIM.

For example, the terminal device transmits, via a first SIM, the terminal capability information on at least one band of the first band combination to a first network device, wherein the at least one band may be one or more bands on which the first SIM operates, or one or more bands on which another SIM of the terminal device operates.

Exemplarily, the at least two SIMs include a first SIM and a second SIM; and the first band combination includes a first band on which the first SIM operates, and a second band on which the second SIM operates, in a case where the at least two SIMs simultaneously operate. That is, the first band combination includes the first band and the second band, wherein the first band is used to indicate one or more operating bands of the first SIM, and the second band is used to indicate one or more operating bands of the second SIM. The terminal device transmits, via the first SIM, first capability information on the first band to the network device; or transmits, via the first SIM, the first capability information on the first band and second capability information on the second band to the network device.

Similarly, the terminal device may also transmit, via the second SIM, the second capability information on the second band of the first band combination to the network device; or transmit, via the second SIM, the first capability information on the first band of the first band combination and the second capability information on the second band of the first band combination to the network device.

Exemplarily, one SIM may operate on at least one band at the same time. That is, the first band includes at least one band, and the second band includes at least one band. In a case where the first band includes at least two bands, the first capability information includes capability information corresponding to at least one of the at least two bands in the first band; and in a case where the second band includes at least two bands, the second capability information includes capability information corresponding to at least one of the at least two bands in the second band.

In other embodiments, the terminal device includes two SIMs, the terminal device transmits, via a first SIM, the terminal capability information on at least one band of the first band combination to a first network device, and transmits, via a second SIM, the terminal capability information on at least one band of the first band combination to a second network device. The first network device and the second network device may be the same or different. The first SIM is used to access the first network device, and the second SIM is used to access the second network device.

The present disclosure introduces the concept of “band combination” to facilitate the terminal device to report communication capabilities of each of a plurality of SIMs for simultaneous operation of the plurality of SIMs to the network device.

The band combination is used to define, in a case where a plurality of SIMs simultaneously operates, operating bands corresponding to respective SIMs simultaneously operating. That is, bands in the band combination refer to operating bands of a plurality of SIMs of the terminal device that simultaneously operate.

In the case where the plurality of SIMs simultaneously operate, operating bands corresponding to respective ones in the plurality of SIMs constitute a band combination. In an example, SIM 1 and SIM 2 of the terminal device simultaneously operate, and SIM 1 operates on Band A, and SIM 2 operates on Band B, such that Band A and Band B forms a band combination, denoted as “Band A+Band B.” In another example, SIM 1 and SIM 2 of the terminal device simultaneously operate, and SIM 1 operates on Band A and Band C, and SIM 2 operates on Band B, such that Band A, Band C, and Band B forms a band combination, denoted as “Band A+Band C+Band B.”

That is, one band combination includes at least two bands corresponding to at least two SIMs respectively, wherein one SIM may correspond to at least one band within the band combination.

The term “band combination” may also have other names. For example, a band combination may also be referred to as a multi-SIM band combination (MSBC), a multi-SIM simultaneous operating band, a multi-SIM simultaneous operating band combination, or the like. That is, a first band combination may also be referred to as a first MSBC.

Exemplarily, band combinations may be classified. In a case where all bands within a first band combination are the same, the first band combination is specified as a first-type band combination; or in a case where some bands within the first band combination are different, the first band combination is specified as a second-type band combination. That is, a first band and a second band in a band combination may be the same or different.

In an example, a first band combination includes Band A on which a first SIM operates and Band A on which a second SIM operates, such that the first band combination is the first-type band combination. In order to report the terminal capability information for the first band combination, the terminal device may report a band combination type (i.e., the first-type band combination) with a corresponding band (i.e., Band A) to indicate the band combination.

In another example, the first band combination includes Band A on which a first SIM operates and Band B on which a second SIM operates, such that the first band combination is the second-type band combination.

Exemplarily, the band combination is referred to as the MSBC, and SIM 1 and SIM 2 are assumed to simultaneously operate, wherein SIM 1 operates on Band A, and SIM 2 operates on Band B. In a case where Band A and Band B are different, Band A and Band B form an inter-band MSBC, denoted as “inter-band MSBC A+B;” or in a case where Band A and Band B are the same, Band A and Band B form an intra-band MSBC, denoted as “intra-band MSBC A+B.”

The terminal device may report the terminal capability information corresponding to one band combination to the network device. Alternatively, the terminal device may report the terminal capability information corresponding to a plurality of band combinations to the network device at the same time. That is, a first band combination may include one or more band combinations.

The terminal device may carry first indication information, second indication information, and terminal capability information for reporting the terminal capability information for one or more bands within the band combination. The first indication information is used to indicate the band combination. For example, the first indication information may be a band combination identifier, bands included in the band combination, a band combination name, or the like. The second indication information is used to indicate the bands within the band combination. For example, the second indication information may be a band identifier, a band name or a band value, or the like. The terminal capability information corresponds to the first indication information and the second indication information, indicating: terminal capability information on a band, indicated by the second indication information, within a band combination indicated by the first indication information.

Alternatively, the terminal device may carry third indication information and terminal capability information for reporting the terminal capability information for one or more bands within the band combination, wherein the third indication information is used to indicate the band combination and the bands within the band combination. For example, the third indication information is “MSBC (A+B, A),” which may indicate Band A within the band combination composed of Band A and Band B. The terminal capability information corresponds to the third indication information. The terminal capability information corresponding to the third indication information indicates: the terminal capability information on the first band of the first band combination indicated by the third indication information.

For performing a terminal capability information report corresponding to a band combination, the terminal device may report the terminal capability information corresponding to one band within the band combination to the network device; or the terminal capability information corresponding to respective bands within the band combination at the same time; or the terminal capability information on at least one band, corresponding to a first SIM, within the band combination via the first SIM; or total terminal capability information for the terminal device operating on a first band combination.

That is, the terminal capability information for the terminal device operating on the first band combination includes at least one of:
terminal capability information corresponding to respective ones of at least one band within the first band combination;
terminal capability information on at least one band, corresponding to the first SIM, within the first band combination; or
information on total capabilities of the terminal device operating on the first band combination (for example, information on a total transmit power or a total receive power of the terminal device, or the like).

In another embodiment, process 210 may be replaced with: the terminal device transmits terminal capability information on at least one band within an MSBC, wherein the MSBC includes, in a case where at least two SIMs of the terminal device simultaneously operate, operating bands respectively used by the at least two SIMs.

In yet another embodiment, process 210 may be replaced with: the terminal device transmits first capability information, wherein the first capability information corresponds to a first SIM and includes capability information in at least one operating mode. The operating mode includes a single-SIM operating mode or a multi-SIM operating mode. The multi-SIM operating mode may also indicate one or more operating bands of the first SIM operating in the multi-SIM operating mode.

That is, the terminal device may report a set of terminal capability information for a SIM, informing the network device of the capability information of the SIM operating in various operating modes. The operating modes include a single-SIM operating mode and a multi-SIM operating mode; or alternatively, the operating modes include a single-SIM operating mode with corresponding bands of the single-SIM operating mode, and a multi-SIM operating mode with corresponding bands of the multi-SIM operating mode.

In some embodiments, the terminal device transmits first capability information, wherein the first capability information includes capability information a corresponding to a first SIM in a single-SIM operating mode and capability information b corresponding to the first SIM in a multi-SIM operating mode. In some embodiments, the terminal device transmits first capability information, wherein the first capability information includes capability information a corresponding to a first band on which a first SIM operates in a single-SIM operating mode, capability information b corresponding to a second band on which the first SIM operates in a multi-SIM operating mode, and capability information c corresponding to a third band on which the first SIM operates in the multi-SIM operating mode. In some embodiments, the terminal device transmits first capability information, wherein the first capability information includes capability information b corresponding to a first SIM in a multi-SIM operating mode.

In still another embodiment, process 210 may be replaced with: the terminal device transmits second capability information, wherein the second capability information corresponds to a first band and includes capability information corresponding to a first SIM operating on the first band in at least one operating mode. In an example, the second capability information includes: capability information of the first SIM operating on the first band in a single-SIM operating mode, and capability information of the first SIM operating on the first band in a multi-SIM operating mode. In another example, the second capability information includes capability information of the first SIM operating on the first band in the multi-SIM operating mode.

That is, the terminal device may report a set of terminal capability information for a band, informing the network device of the capability information corresponding to respective operating modes in a case where the first SIM operates on the band. The operating modes include the single-SIM operating mode and the multi-SIM operating mode.

The single-SIM operating mode refers to an operating mode in which only one SIM of the terminal device is in a connected state. The multi-SIM operating mode refers to an operating mode in which a plurality of SIMs of the terminal device are simultaneously in the connected state.

According to some embodiments, in a case where the terminal device performs 210 via the first SIM, the terminal capability information may only include capability information corresponding to the first SIM. For example, the terminal capability information includes capability information on at least one band, corresponding to the first SIM, within the first band combination.

According to other embodiments, in a case where the terminal device performs 210 via the first SIM, the terminal capability information may include capability information corresponding to a plurality of SIMs, wherein the plurality of SIMs include at least the first SIM. For example, the terminal device may transmit terminal capability information corresponding to a first band combination, wherein the terminal capability information includes capability information corresponding to each band within the first band combination.

Exemplarily, the terminal capability information may be carried in a radio resource control (RRC) message or a medium access control (MAC) control element (CE) message.

Exemplarily, the terminal device may report the terminal capability information in process 210 to the network device upon initial access. That is, the terminal device transmits, upon initial access, the terminal capability information for the first band combination to the network device.

Exemplarily, the terminal device may report, upon initial access, all possible terminal capability information to the network device at one time. For example, the terminal device may report terminal capability information in a single-SIM operating mode, and terminal capability information in a multi-SIM operating mode (including terminal capability information corresponding to each multi-SIM operating situation) to the network device at one time.

Alternatively, the terminal device may report the terminal capability information described in process 210 in RRC UE assistance information. That is, the terminal device transmits the RRC UE assistance information to the network device, wherein the RRC US assistance information includes the terminal capability information for the first band combination.

Exemplarily, in the RRC UE assistance information, the terminal device may report all possible terminal capability information to the network device at one time. For example, the terminal device may report terminal capability information in the single-SIM operating mode and terminal capability information in the multi-SIM operating mode (including terminal capability information corresponding to each multi-SIM operating situation) to the network device at one time.

Exemplarily, in the RRC UE assistance information, the terminal device may only report terminal capability information in one multi-SIM operating situation. For example, the terminal device currently operates in a first multi-SIM operating situation where SIM 1 and SIM 2 simultaneously operate, SIM 1 operates on Band A, and SIM 2 operates on Band B, and the terminal device may report terminal capability information on Band A in MSBC (A+B) to the network device in the RRC UE assistance information.

Exemplarily, the terminal capability information may include at least one of: transmit power capability information; interference indication information; uplink and/or downlink multiple-input multiple-output (MIMO) capability information; supported band information; a number of carriers; or a peak rate.

In summary, in the method according to the above embodiments, the terminal device may report to the network device the capability information of the terminal device on the operating band of each SIM for simultaneous operation of a plurality of SIMs, such that the network device acknowledges communication capabilities of the terminal device in a case where the plurality of SIMs simultaneously operate. In this way, in the case where the plurality of SIMs of the terminal device simultaneously operate, the network device is capable of performing reasonable communication scheduling for each SIM based on the capability information of each SIM on the operating band, such that communication efficiency is improved.

With reference to FIG. 7, FIG. 7 is a flowchart of a method for reporting terminal capabilities according to some embodiments of the present disclosure. The method is performed by a network device, and includes the following process.

In 310, the network device receives terminal capability information for a first band combination from a terminal device, wherein the terminal device includes N SIMs, N being greater than 1, and the first band combination includes operating bands for simultaneous operation of at least two SIMs in the N SIMs.

Exemplarily, the at least two SIMs include a first SIM, and the network device may be accessed by the terminal device via the first SIM.

In response to receiving the terminal capability information, the network device may perform communication scheduling for the terminal device based on the terminal capability information and a current operating mode of the terminal device.

Exemplarily, the at least two SIMs include a first SIM and a second SIM; and the first band combination includes a first band on which the first SIM operates and a second band on which the second SIM operates in a case where the at least two SIMs simultaneously operate. The network device receives first capability information on the first band of the first band combination from the terminal device via the first SIM; or receives first capability information on the first band of the first band combination and second capability information on the second band of the first band combination from the terminal device via the first SIM.

Exemplarily, the first band includes at least one band, and the second band includes at least one band. In a case where the first band includes at least two bands, the first capability information includes capability information corresponding to at least one of the at least two bands in the first band. In a case where the second band includes at least two bands, the second capability information includes capability information corresponding to at least one of the at least two bands in the second band.

Exemplarily, in a case where bands within the first band combination are the same, the first band combination is a first-type band combination; or in a case where bands within the first band combination are different, the first band combination is a second-type band combination.

Exemplarily, the network device may receive, upon completion of initial access by the terminal device, the terminal capability information on at least one band of the first band combination from the terminal device; or alternatively, the network device may receive RRC UE assistance information from the terminal device, wherein the RRC terminal assistance information includes the terminal capability information on at least one band of the first band combination.

Exemplarily, the terminal capability information includes at least one of: transmit power capability information; interference indication information; uplink and/or downlink MIMO capability information; supported band information; a number of carriers; or a peak rate.

In summary, in the method according to the above embodiments, the terminal device may report to the network device the capability information of the terminal device on the operating band of each SIM for simultaneous operation of a plurality of SIMs, such that the network device acknowledges communication capabilities of the terminal device in a case where the plurality of SIMs simultaneously operate. In this way, in the case where the plurality of SIMs of the terminal device simultaneously operate, the network device is capable of performing reasonable communication scheduling for each SIM based on the capability information of each SIM on the operating band, such that communication efficiency is improved.

Exemplarily, the terminal device may also report to the network device a current operating mode of the terminal device, which is convenient for the network device to schedule the communication of the terminal device based on the current operating mode of the terminal device and the terminal capability information on each band in this operating mode.

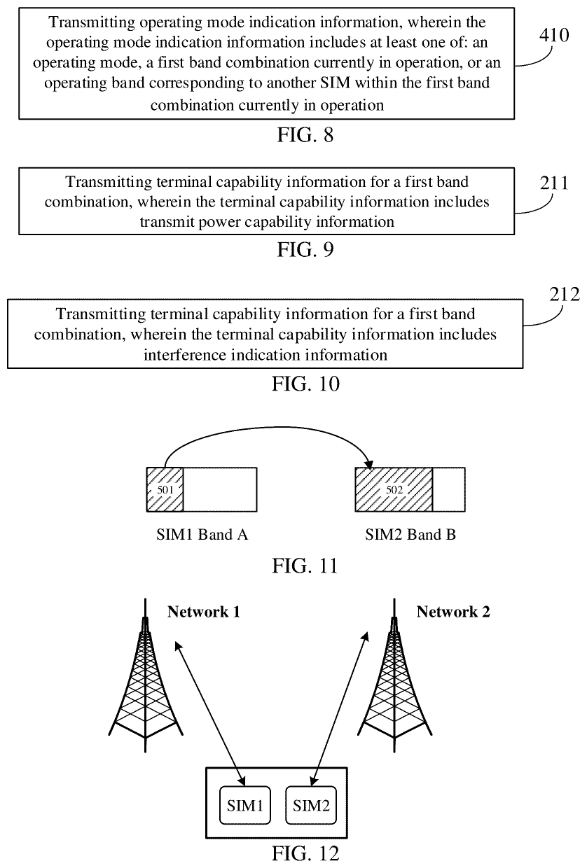

With reference to FIG. 8, FIG. 8 is a flowchart of a method for reporting terminal capabilities according to some embodiments of the present disclosure. The method is performed by a terminal device, and includes the following process.

In 410, the terminal device transmits operating mode indication information, wherein the operating mode indication information includes at least one of: an operating mode, a first band combination currently in operation, or an operating band corresponding to another SIM within the first band combination currently in operation.

The network device receives the operating mode indication information from the terminal device.

The operating mode indication information is used to indicate a current operating mode of the terminal device. The operating mode is used to indicate one of a multi-SIM operating mode, or a single-SIM operating mode. The single-SIM operating mode refers to a mode where only one SIM of the terminal device is in a connected state (i.e., a transmit/receive state). The multi-SIM operating mode refers to a mode where a plurality of SIMs of the terminal device are simultaneously in the connected state (i.e., the transmit/receive state).

Exemplarily, the operating mode indication information may also be used to indicate a future or subsequent operating mode of the terminal device. For example, the operating mode indication information may include: time information, an operating mode, a band combination, and an operating band corresponding to the another SIM. The time information is used to indicate the time for the terminal device to operate in the future operating mode. For example, the time information may include at least one of: a start time, an end time, a time window, a window duration, or a time period, for the terminal device to operate in the future operating mode.

The operating mode indication information may also include relevant information in this indicated operating mode.

In an example, in a case where the indicated operating mode is a multi-SIM operating mode, the operating mode indication information may also include band combination indication information used to indicate a first band combination currently in operation. For example, the band combination indication information may be “MSBC (A+B),” used to indicate that a band combination on which the terminal device currently operates is Band A and Band B.

In another example, in a case where the indicated operating mode is a multi-SIM operating mode, the operating mode indication information may also include an operating band corresponding to another SIM. The another SIM refers to a SIM in the at least two SIMs other than a SIM used to transmit the operating mode indication information. For example, SIM 1 and SIM 2 simultaneously operate, wherein SIM 1 operates on Band A, and SIM 2 operates on Band B, and the operating mode indication information may include: a multi-SIM operating mode and Band B in a case where the terminal device transmits the operating mode indication information via SIM 1, or, the operating mode indication information may include: a multi-SIM operating mode, MSBC (A+B), and Band B. Band B is the operating band of SIM 2 in the multi-SIM operating mode.

Exemplarily, the terminal device may report the operating mode indication information to the network device in real time upon a change to the operating mode. The terminal device may also report the operating mode indication information to the network device in response to an operating mode reporting instruction from the network device.

Process 410 and process 210 may be performed in combination.

In some embodiments, the terminal capability information and the operating mode indication information may be carried in the same message for reporting.

In some embodiments, the terminal device transmits the terminal capability information on at least one band of the first band combination, and the operating mode indication information. Alternatively, the terminal device transmits an RRC message, wherein the RRC message includes the terminal capability information on at least one band of the first band combination and the operating mode indication information. In some embodiments, the terminal device transmits an MAC CE message, wherein the MAC CE message includes the terminal capability information on at least one band of the first band combination and the operating mode indication information.

In the embodiments where the terminal capability information and the operating mode indication information are carried in the same message, the terminal capability information reported by the terminal device may correspond to the current operating mode of the terminal device. For example, in a case where the terminal device operates on the first band combination in a multi-SIM operating mode, the terminal device may report the terminal capability information for at least one band within the first band combination and the operating mode indication information, wherein the operating mode indication information includes the multi-SIM operating mode and the first band combination.

The terminal capability information reported by the terminal device is not limited to the terminal capability information corresponding to the current operating mode. For example, the terminal device may report terminal capability information corresponding to all possible operating situations and the operating mode indication information corresponding to the current operating mode of the terminal device.

In some embodiments, the terminal capability information and the operating mode indication information may be reported in different messages respectively. The order for reporting the terminal capability information and the operating mode indication information is not limited.

In an example, the terminal device may report the terminal capability information first, and then report the operating mode indication information. The terminal device transmits the terminal capability information on at least one band of the first band combination; and then the terminal device transmits the operating mode indication information. The terminal capability information may be carried in an RRC message or an MAC CE message. The operating mode indication information may also be carried in an RRC message or an MAC CE message.

In another example, the terminal device may transmit, upon initial access, the terminal capability information on at least one band of the first band combination to the network device. The first band combination includes all possible band combinations on which the terminal device may operate, that is, the terminal capability information includes terminal capability information corresponding to respective ones of all possible operating situations of the terminal device. Then, the terminal device reports the operating mode indication information of the current operating mode to the network device in real time. The network device determines the current operating mode and corresponding operating bands of the terminal device based on the operating mode indication information, and queries terminal capability information for the terminal device on the operating bands of the reported operating mode based on the terminal capability information.

In summary, in the method according to the above embodiments, the terminal device may also report the operating mode indication information to the network device to inform the network device of the current operating mode of the terminal device. The network device is allowed to determine the current communication capabilities of the terminal device based on the operating mode indication information, and then perform reasonable communication scheduling for the terminal device to improve communication efficiency.

Exemplarily, the terminal capability information may include transmit power capability information.

With reference to FIG. 9, FIG. 9 is a flowchart of a method for reporting terminal capabilities according to some embodiments of the present disclosure. The method is performed by a terminal device. Based on the embodiment illustrated in FIG. 6, process 210 may include the following process.

In 211, the terminal device transmits terminal capability information for a first band combination to a network device, wherein the terminal capability information includes transmit power capability information.

The network device receives the terminal capability information on at least one band of the first band combination, wherein the terminal capability information includes transmit power capability information. Exemplarily, the network device performs transmit power control and/or mobility management for the terminal device based on the transmit power capability information.

Exemplarily, the terminal capability information includes at least one of:
1) Transmit power capability information on one or more operating bands corresponding to at least one SIM in at least two SIMs, in a case where the at least two SIMs simultaneously operate. That is, the transmit power capability information corresponds to at least one band within the first band combination;
2) Total transmit power capability information of the terminal device, in a case where the at least two SIMs simultaneously operate, i.e., information on overall transmit power capabilities of the terminal device.

That is, the terminal device may report transmit powers corresponding to respective operating bands of each SIM in the multi-SIM operating mode, and/or the transmit powers corresponding to each SIM, and/or the total transmit power of the terminal device in the multi-SIM operating mode.

In an example where SIM 1 and SIM 2 simultaneously operate, SIM 1 operates on Band A and Band C, and SIM 2 operates on Band B, the terminal device may report, to the network device, at least one of:
a first transmit power of SIM 1 on Band A;
a second transmit power of SIM 1 on Band C;
a third transmit power of SIM 2 on Band B;
a total transmit power of SIM 1 which is not greater than the sum of the first transmit power and the second transmit power;
a total transmit power of SIM 2 which is not greater than the third transmit power; or
a total transmit power of MSBC (A+C+B) which is not greater than the sum of the first transmit power, the second transmit power, and the third transmit power. The total transmit power of MSBC (A+C+B) may also be referred to as the total transmit power of the terminal device.

The transmit power capability information may include a maximum transmit power. The transmit power capability information may be used to specify the maximum transmit power of each SIM on each band in a case where a plurality of SIMs simultaneously operate. In some embodiments, the transmit power capability information may be used to specify the maximum transmit power of each SIM in a case where a plurality of SIMs simultaneously operate. In some embodiments, the transmit power capability information may be used to specify the maximum transmit power of the terminal device in a case where a plurality of SIMs simultaneously operate.

The network device may perform communication scheduling for each band of each SIM based on the transmit power capability information.

Alternatively, the network device may dynamically allocate power among the plurality SIMs without exceeding the total transmit power of the terminal device. Alternatively, the network device may use the total transmit power to limit the terminal device from causing human radiation safety issues due to an excessive total transmit power.

Exemplarily, the transmit power may be indicated by power class (PC) or by specific values.

In summary, in the method according to the above embodiments, the terminal device may report the transmit power capability information of the terminal device in the multi-SIM operating mode to the network device, such that the network device performs communication scheduling based on the transmit power of the terminal device in the multi-SIM operating mode. By reporting information such as the per-SIM transmit power and the total maximum transmit power under a multi-SIM concurrent scenario corresponding to the MSBC, the terminal device reports the multi-SIM transmit power limit of the terminal device to the base station. Upon receiving the above information, the base station may perform transmit power control and mobility management (such as determination of handover thresholds) based on the transmit power corresponding to each SIM in the multi-SIM simultaneous operation scenario, instead of following the power class limit in a single-SIM mode, improving the rationality of communication scheduling by the network device and communication efficiency.

Exemplarily, the terminal capability information may include interference indication information.

With reference to FIG. 10, FIG. 10 is a flowchart of a method for reporting terminal capabilities according to some embodiments of the present disclosure. The method is performed by a terminal device. Based on the embodiment illustrated in FIG. 6, process 210 may include process 212.

In 212, the terminal device transmits terminal capability information for a first band combination to a network device, wherein the terminal capability information includes interference indication information.

The network device receives the terminal capability information on at least one band of the first band combination, wherein the terminal capability information includes the interference indication information.

In a case where the terminal device operates in a multi-SIM operating mode, mutual interference may be present between bands of a plurality of SIMs of the terminal device. For example, SIM 1 operates on Band A, SIM 2 operates on Band B, and a second harmonic of Band A falls within Band B. In this example, a signal transmitted by SIM 1 on Band A may interfere with signal reception by SIM 2 on Band B. Therefore, to reduce the mutual interference in the multi-SIM operating mode, the terminal device may report the interference indication information to the network device, enabling the network device to schedule communication resources for bands of each SIM of the terminal device based on the interference indication information, and thereby minimizing the mutual interference as much as possible.

Exemplarily, the terminal capability information includes at least one of the following interference indication information in a case where at least two SIMs simultaneously operate: an interference scenario, an interference intensity, or an operating band corresponding to each SIM within the first band combination. Exemplarily, the terminal capability information includes at least one of: an interference scenario, an interference intensity, or an operating band corresponding to each SIM within the first band combination.

The interference scenario includes at least one of: an interference source band, an interfered band, or an interference type.

In a case where Band A on which SIM 1 operates interferes with Band B on which SIM 2 operates, the interference indication information reported by SIM 2 indicates that the interference source band is Band A and the interfered band is Band B, or that the interference source band is Band A and the interfered band is an interfered frequency interval within Band B.

The interference type includes at least one of: harmonic interference, intermodulation interference, out-of-band leakage interference, or harmonic mixing interference.

In a case where SIM 1 and SIM 2 simultaneously operate in a connected state, and the current band combination is: Band A on which SIM 1 operates and Band B on which SIM 2 operates, and the second harmonic of Band A on which SIM 1 operates interferes with Band B on which SIM 2 operates, the terminal device may report the following interference indication information to the network device:
a band combination is MSBC (A+B);
an operating band of SIM 1 is Band A;
an operating band of SIM 2 is Band B;
an interference type is harmonic interference (or second harmonic);
an interfered band is Band B;
an interference-applying band (i.e., an interference source band) is Band A;
an interference intensity;
a maximum sensitivity degradation (MSD); and
a receive sensitivity of the interfered band.

The interference intensity may be a signal intensity of an interference signal that falls within the interfered band.

The MSD is used to characterize a reduced receive sensitivity of the interfered band due to interference. The MDS is a difference between a maximum receive sensitivity of the interfered band when not interfered and a maximum receive sensitivity of the interfered band upon being interfered.

The receive sensitivity of the interfered band refers to the receive sensitivity of the interfered band upon being interfered.

Exemplarily, the interference source band and the interfered band may be bands within the first band combination.

Exemplarily, the present disclosure also provides the following four interference resolution methods.

In method (1), a transmit/receive frequency is adjusted to avoid the interfered frequency.

The network device transmits first indication information to the terminal device, wherein the first indication information is used to adjust a transmit frequency and/or a receive frequency in one or more operating bands of at least one SIM in the at least two SIMs. The first indication information is determined by the network device based on the interference indication information.

The terminal device receives the first indication information from the network device.

Exemplarily, the first indication information is used to adjust a transmit frequency of an interference source band, and/or the first indication information is used to adjust a receive frequency of an interfered band.

For example, as illustrated in FIG. 11, SIM 1 and SIM 2 simultaneously operate in a connected state, and a current band combination is: Band A on which SIM 1 operates and Band B on which SIM 2 operates, and the second harmonic of Band A on which SIM 1 operates interferes with Band B on which SIM 2 operates. The second harmonic of a first frequency interval 501 of Band A falls within a second frequency interval 502 of Band B. In this case, the first indication information may be used to indicate that a transmit frequency of SIM 1 is: a frequency interval in Band A except the first frequency interval 501 (a white portion of Band A as shown). And/or, the first indication information may be used to indicate that a receive frequency of SIM 2 is: a frequency interval in Band B except the second frequency interval 502 (a white portion of Band B as shown).

In method (2), a transmit power of an interference source band is adjusted to reduce an interference intensity.

For example, SIM 1 and SIM 2 simultaneously operate in a connected state, and a current band combination is: Band A on which SIM 1 operates and Band B on which SIM 2 operates, and the second harmonic of Band A on which SIM 1 operates interferes with Band B on which SIM 2 operates. In this case, an interference intensity of a signal transmitted on Band A to Band B may be reduced by adjusting the transmit power of Band A.
a. The terminal device may voluntarily adjust a transmit power of an interference source band.

That is, the terminal device adjusts the transmit power of the interference source band based on the interference indication information.
b. The terminal device may adjust the transmit power of the interference source band based on an instruction from the network device.

That is, the network device transmits second indication information to the terminal device, wherein the second indication information is used to adjust the transmit power of the interference source band, and determined by the network device based on the interference indication information.

The terminal device receives the second indication information from the network device, and adjusts the transmit power of the interference source band based on the second indication information.

In method (3), a time-division multiplexing (TDM) mode is adopted for transmission and reception on an interfered band to avoid interference.

The network device transmits a transmission resource configuration to the terminal device, wherein the transmission resource configuration is used to configure one or more transmission resources for at least one SIM of the at least two SIMs. The transmission resource configuration is acquired by the network device via a configuration in the TDM mode based on the interference indication information.

The terminal device receives the transmission resource configuration and controls data transmission of the plurality of SIMs based on the transmission resource configuration.

Exemplarily, in the transmission resource configuration, uplink transmission resources used by an interference source band and downlink transmission resources used by an interfered band are different in time domain. For example, the uplink transmission resources used by the interference source band are located in a first time interval, and the downlink transmission resources used by the interfered band are located in a second time interval, wherein the first time interval and the second time interval are not overlapped with each other.

For example, SIM 1 and SIM 2 simultaneously operate in a connected state, and a current band combination is: Band A on which SIM 1 operates and Band B on which SIM 2 operates, and the second harmonic of Band A on which SIM 1 operates interferes with Band B on which SIM 2 operates. In this case, the network device may configure first time domain resources for Band A for uplink transmission, and configure second time domain resources for Band B for downlink reception, wherein the first time domain resources are not overlapped in time with the second time domain resources.

In summary, in the method according to the above embodiments, the terminal device may report interference indication information of the terminal device in the multi-SIM operating mode to the network device, wherein the interference indication information includes mutual interference information between bands within the band combination in the multi-SIM operating mode. The network device may perform communication scheduling for the terminal device based on the interference indication information, and reduce mutual interference between the bands in the terminal device by adjusting the transmit and receive frequencies, reducing the transmit power, adopting the TDM mode, or other means, thereby improving communication efficiency.

FIG. 12 is a schematic diagram of a DSDA terminal device, where the terminal device communicates with Network 1 via SIM 1, and the terminal device communicates with Network 2 via SIM 2. Exemplarily, from the perspective of the network, different SIMs represent different terminal devices. Therefore, the processing of SIM 1 and SIM 2 on the network side is carried out as if they were different terminal devices, i.e., following the communication capabilities reported by SIM 1 and SIM 2 respectively.

However, in practical applications where SIM 1 and SIM 2 included within the same terminal device, and SIM 1 and SIM 2 are required to share some communication resources (such as hardware resources), a difference may be generated between actual communication capabilities of SIM 1 and SIM 2 and capabilities reported by each SIM individually, causing the base station to fail to schedule the terminal device correctly. It should be noted that the mutual influence between a plurality of SIMs is related to the operating band corresponding to each SIM. Some bands may have mutual influence, while other bands may not. The concept of “multi-SIM band combination (MSBC)” is introduced below to describe how to coordinate capability information between the plurality of SIMs.

### Embodiment 1: MSBC-Based Capability Information Interaction

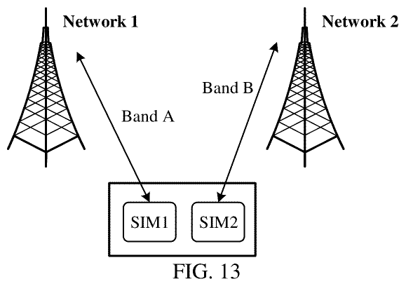

As illustrated in FIG. 13, an MSBC refers to a scenario where SIM 1 and SIM 2 simultaneously operate, and SIM 1 operates on Band A, and SIM 2 operates on Band B. In this case, the combination of Band A and Band B constitutes a multi-SIM band combination (i.e., multi-SIM band combination A+B, hereinafter referred to as “MSBC A+B”). In a case where Band A and Band B are different, the combination of Band A and Band B constitutes an inter-band MSBC A+B; or in a case where Band A and Band B are the same, the combination of Band A and Band B constitutes an intra-band MSBC A+B.

It should be noted that each SIM may also operate on a band combination composed of a plurality of bands, such as SIM 1 operating on Band K+Band L, SIM 2 operating on Band M+Band N, or the like. For the sake of simplicity, each SIM is assumed herein to operate on only one band.

For an MSBC composed of two bands (Band A+Band B) that have mutual influence, in a case where the two bands are simultaneously in the operating state, each of the two bands may not be able to perform transmission or reception completely in accordance with individual operational capabilities. However, current transmission and reception capabilities of the terminal device are reported based on each SIM operating individually. For example, SIM 1 may report the transmission and reception capabilities of Band A to Network 1, and SIM 2 may report the transmission and reception capabilities of Band B to Network 2. This mechanism fails to reflect the real transmission and reception capabilities in a case where Band A and Band B simultaneously operate. Therefore, based on the introduced MSBC, the communication capabilities of MSBC A+B in which Band A and Band B simultaneously operate may be reported to Network 1 and/or Network 2, such that the base station knows the real communication capabilities of the terminal device in a multi-SIM simultaneous operating mode and perform accurate scheduling for the terminal device. The reporting method may include:
1) The communication capabilities corresponding to MSBC A+B may be reported to the base stations corresponding to the SIMs respectively upon initial access, wherein different communication capability information is used by the terminal device operating in a single-SIM mode and a dual-SIM mode, respectively.
2) The communication capabilities corresponding to MSBC A+B may also be reported via RRC UE assistant information.

A multi-SIM terminal device may operate in a single-SIM mode (or referred to as a single-SIM operating mode) or a multi-SIM mode (or referred to as a multi-SIM operating mode). Whether the terminal device operates in the multi-SIM mode at a certain moment is required to be indicated by the terminal device to the network, that is, in a case where the terminal device operates in the multi-SIM mode, the terminal device is required to report to the base station(s) corresponding to SIM 1 and/or SIM 2 at least one of:
currently operating in a multi-SIM operating mode;
one or more operating band corresponding to another SIM; or
an MSBC.

Introduction to the reporting and use of MSBC communication capabilities are provided hereinafter by using two examples of uplink transmit power control and interference coordination, respectively.

### Example 1: MSBC-Based Uplink Transmit Power Control

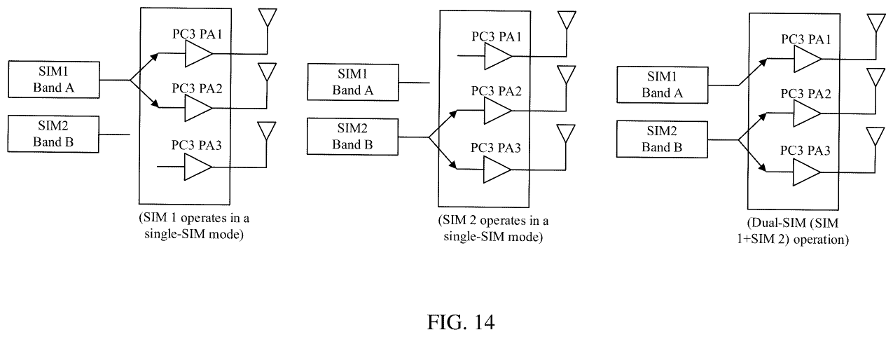

In a case where SIM 1 and SIM 2 operate on Band A and Band B individually, transmit power classes corresponding to SIM 1 and SIM 2 are PC 2. In an example as illustrated in FIG. 14, SIM 1 on Band A uses power amplifiers PA 1 and PA 2 to reach PC 2, and SIM 2 on Band B uses PA 2 and PA 3 to reach PC 2. However, in a case where Band A and Band B simultaneously operate, one of Band A and Band B may fail to reach PC 2, which means that actual communication capabilities are inconsistent with communication capabilities for operation by a single band. To address this problem, the definition of an MSBC-based transmit power capability is introduced by considering that the transmit power class of the terminal device directly affects uplink coverage, power control, mobility, or the like, which is of great significance to the base station.

The MSBC-based transmit power capability may include one or more of:
(1) Transmit power capability information of a band (or a band combination) corresponding to each SIM.

The transmit power capability information is used to clarify a maximum transmit power capability of each SIM in a case where a plurality of SIMs simultaneously operate.

The transmit power capability information may be used for scheduling by a network corresponding to each SIM in the case of multi-SIM simultaneous operation on the band.
(2) A total transmit power capability of MSBC A+B.

The total transmit power capability may represent the total transmit power capability of the terminal device in a multi-SIM concurrent scenario.

The total transmit power capability information has practical value in various scenarios. For example, the base station may dynamically allocate power between two SIMs without exceeding the total transmit power, and limit the terminal device from causing human radiation safety problems due to excessive total transmit power, or the like.

In an example as illustrated in FIG. 14, power class definitions based on MSBC in a multi-SIM simultaneous operation scenario (i.e., a dual-SIM (SIM 1+SIM 2) operation scenario in the schematic diagram of FIG. 14) is as listed in Table 1.

TABLE 1

| | Power Class of | Power Class of | Total maximum |
|---|---|---|---|
| Multi-SIM Band | Band A | Band B | power of MSBC |
| Combination | under MSBC | under MSBC | A + B |
| A + B | PC3 | PC2 | 27 dBm |

Note 1:
In this example, the total maximum power of MSBC A + B should be 27.8 dBm in a case where transmission is performed in accordance with the maximum PA capability of Band A + B in FIG. 14, but limited to 27 dBm herein to illustrate that in some cases, the total maximum power requirement of MSBC A + B may not always be equal to the sum of the power classes of Band A and Band B under MSBC. A typical example is that to meet human radiation safety requirements, the total transmit power of a plurality of SIMs cannot be too large, and thus the total maximum power of MSBC A + B is limited to 27 dBm herein.
Note 2:
The total maximum power of MSBC A + B may also be expressed in the form of power class, such as using PC2 herein instead of 27 dBm. In contrast, using a specific power value may have more freedom. For example, the total maximum power of MSBC A + B may be the transmit power corresponding to the power class (e.g., 26 dBm corresponding to PC2) or any transmit power.

In Example 1, the terminal device may report the multi-SIM transmit power limit of the terminal device to the base station by reporting information such as the per-SIM transmit power and the total maximum transmit power in the multi-SIM concurrent scenario corresponding to MSBC. In response to receiving the above information, the base station may perform transmit power control and mobility management (such as determination of handover thresholds) based on PC3 for Band A and PC2 for Band B in the multi-SIM simultaneous operation scenario, instead of following the power class limits of Band A and Band B in a single-SIM mode.

### Example 2: MSBC-Based Interference Coordination

Compared with a single-SIM operation, the multi-SIM simultaneous operation may be subject to interference. As illustrated in FIG. 15, a harmonic of a transmit signal on Band A falls within a receive frequency range of Band B, which may cause a received signal on Band B to be interfered. In this case, receive capabilities of Band B may deteriorate, and in severe cases, downlink reception on Band B may be interrupted. Currently, no corresponding solution is available for mitigating mutual interference in the scenario where a plurality of SIMs simultaneously operate. The discussion provided hereinafter leverages MSBC to explain how to mitigate the interference among the plurality of SIMs.

Various scenarios of mutual interference of MSBC A+B are present, such as harmonic interference, intermodulation interference, out-of-band leakage interference, harmonic mixing interference, or the like. Each type of interference scenario has corresponding occurrence conditions. For example, harmonic interference usually occurs in a case where a multiplied frequency of a transmit band falls within a receive band, resulting in deterioration of a signal-to-noise ratio of a received signal and decline of a receive quality. Therefore, interference solutions are usually aimed at these conditions under which the interferences occur.

### 1. Interference Indication

A base station accessed by SIM 2 may not know that a current interference comes from SIM 1. Therefore, MSBC is required to report, to a base station corresponding to at least one of SIM 1 or SIM 2, information about an interference scenario (such as an interference source band, an interfered band, or an interference type) and an interference intensity in case of simultaneous operation of a plurality of SIMs. Furthermore, possible interference may be determined by indicating current operating bands corresponding to two SIMs to the base station.

For example, information as listed in Table 2 may be reported to the base station.

TABLE 2

| | | | | | Interference |
|---|---|---|---|---|---|
| | | | | | intensity |
| | | | | | or MSD or |
| Operating | Operating | | | Interference- | receive |
| band of | band of | Interference | Interfered | applying | sensitivity |
| SIM 1 | SIM 2 | Type | band | band | of Band B |
| Band A | Band B | Second | Band B | Band A | X dB |
| | | harmonic | | | |

Note 1:
The reported information may include only one or more of the listed information elements.
Note 2:
A way to characterize an interference magnitude may be a magnitude of the interference intensity of a signal falling within the interfered band (Band B), or sensitivity loss (MSD) of the interfered band (Band B) caused by the interference, or the receive sensitivity of the interfered band upon being interfered.

### 2. Interference Mitigation

In the above MSBC A+B example, the second harmonic of the transmitted signal on Band A falls within the receive band of Band B, causing performance of a receiver on Band B to decline. To mitigate the interference, a plurality of methods may be adopted. For example, the methods include:
(1) A transmit frequency of SIM 1 on Band A and/or a receive frequency of SIM 2 on Band B is adjusted, such that a harmonic of the transmit frequency of SIM 1 on Band A may not fall within the receive frequency of SIM 2 on Band B.

As illustrated in FIG. 11, a shaded area of Band B represents an interference frequency interval caused by an actual transmit frequency (shaded area) of SIM 1 on Band A. In a case where SIM 2 operates in an interval as shown in a white portion of Band B, the interference from SIM 1 is avoided.
(2) A transmit power of SIM 1 is adjusted to reduce the interference to SIM 2.
(3) A TDM mode is adopted for SIM 1 and SIM 2, such that SIM 2 does not perform reception during transmission performed by SIM 1, to avoid interference.

The interference indication corresponding to MSBC in case of simultaneous operation of a plurality of SIMs assists the base station in avoiding interference.

It should be noted that processes in the methods according to the above embodiments may be combined arbitrarily to derive new embodiments, which are not limited by the present disclosure.

FIG. 16 is a structural block diagram of an apparatus for reporting terminal capabilities according to some embodiments of the present disclosure. The apparatus may be implemented as a terminal device or a part of a terminal device.

The apparatus includes at least two SIMs, and includes: a first transmitting module 801, configured to transmit terminal capability information for a first band combination to a network device, wherein the first band combination includes operating bands for simultaneous operation of the at least two SIMs.

In some embodiments, the at least two SIMs include a first SIM and a second SIM; and the first band combination includes a first band and a second band, wherein the first band is used to indicate an operating band of the first SIM, and the second band is used to indicate an operating band of the second SIM; and the first transmitting module 801 is configured to transmit, via the first SIM, first capability information on the first band to the network device; or transmit, via the first SIM, first capability information on the first band and second capability information on the second band to the network device.

In some embodiments, the first band includes at least one band, and the second band includes at least one band. In a case where the first band includes at least two bands, the first capability information includes capability information corresponding to at least one band in the first band; and in a case where the second band includes at least two bands, the second capability information includes capability information corresponding to at least one band in the second band.

In some embodiments, the first band is the same as or different from the second band.

In some embodiments, the first transmitting module 801 is configured to transmit, upon initial access, the terminal capability information for the first band combination to the network device; or transmit RRC UE assistance information to the network device, wherein the RRC UE assistance information includes the terminal capability information for the first band combination.

In some embodiments, the first transmitting module 801 is configured to transmit operating mode indication information, wherein the operating mode indication information includes at least one of: an operating mode, the first band combination currently in operation, or an operating band corresponding to another SIM within the first band combination currently in operation; wherein the operating mode is used to indicate one of: a multi-SIM operating mode or single-SIM operating mode; and the another SIM is a SIM in the at least two SIMs other than a SIM used to transmit the operating mode indication information.

In some embodiments, the terminal capability information includes at least one of: transmit power capability information; interference indication information; uplink and/or downlink MIMO capability information; supported band information; a number of carriers; or a peak rate.

In some embodiments, the terminal capability information includes at least one of: transmit power capability information corresponding to at least one band within the first band combination; or total transmit power capability information of the terminal device.

In some embodiments, the terminal capability information includes at least one of following interference indication information: an interference scenario, an interference intensity, or an operating band corresponding to each SIM within the first band combination; wherein the interference scenario includes at least one of: an interference source band, an interfered band, or an interference type.

In some embodiments, the apparatus further includes: a first receiving module 803, configured to receive first indication information from the network device, wherein the first indication information is used to adjust a transmit frequency and/or a receive frequency in the operating band of at least one SIM in the at least two SIMs, and the first indication information is determined by the network device based on the interference indication information.

In some embodiments, the apparatus further includes: a first processing module 802, configured to adjust a transmit power of the interference source band based on the interference indication information.

In some embodiments, the apparatus further includes: a first receiving module 803, configured to receive second indication information from the network device, wherein the second indication information is used to adjust a transmit power of the interference source band, and the second indication information is determined by the network device based on the interference indication information.

In some embodiments, the apparatus further includes: a first receiving module 803, configured to receive a transmission resource configuration from the network device, wherein the transmission resource configuration is used to configure a transmission resource for at least one SIM in the at least two SIMs, and the transmission resource configuration is acquired by the network device via a configuration in a TDM mode based on the interference indication information.

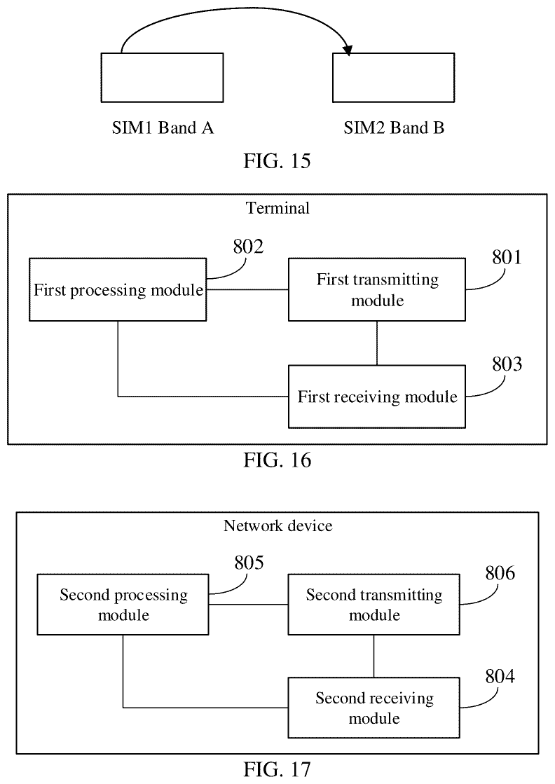

FIG. 17 is a structural block diagram of an apparatus for reporting terminal capabilities according to some embodiments of the present disclosure.

The apparatus may be implemented as a network device or a part of a network device, and includes: a second receiving module 804, configured to receive terminal capability information for a first band combination from a terminal device, wherein the terminal device includes at least two SIMs, and the first band combination includes operating bands for simultaneous operation of the at least two SIMs.

In some embodiments, the at least two SIMs include a first SIM and a second SIM; and the first band combination includes a first band and a second band, the first band is used to indicate an operating band of the first SIM, and the second band is used to indicate an operating band of the second SIM; and the second receiving module 804 is configured to receive, from the terminal device, first capability information on the first band transmitted via the first SIM; or receive, from the terminal device, first capability information on the first band and second capability information on the second band transmitted via the first SIM.

In some embodiments, the first band includes at least one band, and the second band includes at least one band. In a case where the first band includes at least two bands, the first capability information includes capability information corresponding to at least one band in the first band; and in a case where the second band includes at least two bands, the second capability information includes capability information corresponding to at least one band in the second band.

In some embodiments, the first band is the same as or different from the second band.

In some embodiments, the second receiving module 804 is configured to receive, upon initial access, the terminal capability information for the first band combination from the terminal device; or receive RRC UE assistance information from the terminal device, wherein the RRC UE assistance information includes the terminal capability information for the first band combination.

In some embodiments, the second receiving module 804 is configured to receive operating mode indication information from the terminal device, wherein the operating mode indication information includes at least one of: an operating mode, the first band combination currently in operation, or an operating band corresponding to another SIM within the first band combination currently in operation;
wherein the operating mode is used to indicate one of: a multi-SIM operating mode or a single-SIM operating mode; and the another SIM is a SIM in the at least two SIMs other than a SIM used to transmit the operating mode indication information.

In some embodiments, the terminal capability information includes at least one of: transmit power capability information; interference indication information; uplink and/or downlink MIMO capability information; supported band information; a number of carriers; or a peak rate.

In some embodiments, the terminal capability information includes at least one of: transmit power capability information corresponding to at least one band within the first band combination; or total transmit power capability information for the terminal device.

In some embodiments, the apparatus further includes: a second processing module 805, configured to perform transmit power control and/or mobility management of the terminal device based on the transmit power capability information.

In some embodiments, the terminal capability information includes at least one of following interference indication information: an interference scenario, an interference intensity, or an operating band corresponding to each SIM within the first band combination; wherein the interference scenario includes at least one of: an interference source band, an interfered band, or an interference type.

In some embodiments, the apparatus further includes: a second transmitting module 806, configured to transmit first indication information to the terminal device, wherein the first indication information is used to adjust a transmit frequency and/or a receive frequency in the operating band of at least one SIM in the at least two SIMs, and the first indication information is determined by the network device based on the interference indication information.

In some embodiments, the apparatus further includes: a second transmitting module 806, configured to transmit second indication information to the terminal device, wherein the second indication information is used to adjust a transmit power of the interference source band, and the second indication information is determined by the network device based on the interference indication information.

In some embodiments, the apparatus further includes: a second transmitting module 806, configured to transmit a transmission resource configuration to the terminal device, wherein the transmission resource configuration is used to configure a transmission resource for at least one SIM in the at least two SIMs, and the transmission resource configuration is acquired by the network device via a configuration in a TDM mode based on the interference indication information.

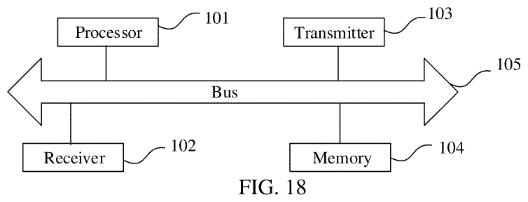

FIG. 18 is a schematic diagram of a communication device (including a terminal device or a network device) according to some embodiments of the present disclosure.

The communication device includes: a processor 101, a receiver 102, a transmitter 103, a memory 104, and a bus 105.

The processor 101 includes one or more processing cores. By running software programs and modules, the processor 101 executes various functional applications and information processing.

The receiver 102 and the transmitter 103 may be implemented as a single communication component, which may be a communication chip and may be referred to as a transceiver.

The memory 104 is communicably connected to the processor 101 via the bus 105.

The memory 104 may be configured to store at least one instruction. The processor 101 is configured to execute the at least one instruction to perform the various processes in the method embodiments as described above.

Furthermore, the memory 104 may be implemented by any type of volatile or non-volatile storage device or a combination thereof, including but not limited to: a magnetic or optical disk, an electrically erasable programmable read-only memory (EEPROM), an erasable programmable read-only memory (EPROM), a static random-access memory (SRAM), a read-only memory (ROM), a magnetic memory, a flash memory, and a programmable read-only memory (PROM).

In a case where the communication device is implemented as a terminal device, the processor and transceiver in the communication device involved in the embodiments of the present disclosure may perform the processes performed by the terminal device in any of the above methods, which are not elaborated herein.

In some embodiments, in a case where the communication device is implemented as a terminal device, the transceiver is configured to transmit terminal capability information for a first band combination to a network device, wherein the first band combination includes operating bands for simultaneous operation of the at least two SIMs, and the terminal device includes the at least two SIMs.

In other embodiments, in a case where the communication device is implemented as a network device, the transceiver is configured to receive terminal capability information for a first band combination from a terminal device, wherein the terminal device includes at least two SIMs, and the first band combination includes operating bands for simultaneous operation of the at least two SIMs.

Some embodiments of the present disclosure further provide a computer-readable storage medium. The computer-readable storage medium stores at least one instruction, at least one program, a code set, or an instruction set. The at least one instruction, the at least one program, the code set, or the instruction set, when loaded and executed by a processor, causes the processor to perform the method for reporting terminal capabilities performed by the communication device according to the above method embodiments.

Some embodiments of the present disclosure further provide a chip. The chip includes programmable logic circuitry and/or one or more program instructions. The chip, when running on a communication device, is configured to cause the communication device to perform the method for reporting terminal capabilities according to the above method embodiments.

Some embodiments of the present disclosure further provide a computer program product. The computer program product, when running on a processor of a communication device, causes the communication device to perform the method for reporting terminal capabilities according to the above method embodiments.

A person of ordinary skill in the art should be aware that all or portions of the processes for implementing the aforementioned embodiments may be accomplished by hardware, or may be executed by instructing relevant hardware via a program. The program may be stored in a computer-readable storage medium. The storage medium may include a read-only memory (ROM), a magnetic disk, an optical disc, or the like.

Described above are merely optional embodiments of the present disclosure and are not used to limit the present disclosure. Any modifications, equivalent substitutions, improvements, and the like made within the spirit and principles of the present disclosure shall be included within the protection scope of the present disclosure.

What is claimed is:

1. A terminal device, comprising N subscriber identity modules (SIMs), N being greater than 1, the terminal device comprising: a processor and a transceiver communicably connected to the processor;
wherein the transceiver is configured to transmit terminal capability information for a first band combination to a network device, wherein the first band combination comprises operating bands for simultaneous operation of at least two SIMs in the N SIMs.

2. The terminal device according to claim 1, wherein the at least two SIMs comprise a first SIM and a second SIM; and the first band combination comprises a first band and a second band, wherein the first band is used to indicate an operating band of the first SIM, and the second band is used to indicate an operating band of the second SIM; and
the transceiver is further configured to:
transmit, via the first SIM, first capability information on the first band to the network device, and transmit, via the second SIM, second capability information on the second band in the first band combination; or
transmit, via the first SIM, first capability information on the first band and second capability information on the second band to the network device.

3. The terminal device according to claim 2, wherein the first band comprises at least one band, and the second band comprises at least one band; wherein
in a case where the first band comprises at least two bands, the first capability information comprises capability information corresponding to at least one band in the first band; and
in a case where the second band comprises at least two bands, the second capability information comprises capability information corresponding to at least one band in the second band.

4. The terminal device according to claim 1, wherein the transceiver is further configured to:
transmit, upon initial access, the terminal capability information for the first band combination to the network device; or
transmit radio resource control (RRC) user equipment (UE) assistance information to the network device, wherein the RRC UE assistance information comprises the terminal capability information for the first band combination.

5. The terminal device according to claim 1, wherein the transceiver is further configured to:
transmit operating mode indication information, wherein the operating mode indication information comprises at least one of: an operating mode, the first band combination currently in operation, or an operating band corresponding to another SIM within the first band combination currently in operation;
wherein the operating mode is used to indicate one of: a multi-SIM operating mode or a single-SIM operating mode; and the another SIM is a SIM in the at least two SIMs other than a SIM used to transmit the operating mode indication information.

6. The terminal device according to claim 1, wherein the terminal capability information comprises at least one of:
transmit power capability information;
interference indication information;
uplink and/or downlink multiple-input multiple-output (MIMO) capability information;
supported band information;
a number of carriers; or
a peak rate.

7. The terminal device according to claim 1, wherein the terminal capability information comprises at least one of:
transmit power capability information corresponding to at least one band within the first band combination; or
total transmit power capability information of the terminal device.

8. The terminal device according to claim 1, wherein the terminal capability information comprises at least one of following interference indication information: an interference scenario, an interference intensity, or an operating band corresponding to each SIM within the first band combination;
wherein the interference scenario comprises at least one of: an interference source band, an interfered band, or an interference type.

9. The terminal device according to claim 8, wherein the transceiver is further configured to:
receive first indication information from the network device, wherein the first indication information is used to adjust a transmit frequency and/or a receive frequency in the operating band of at least one SIM in the at least two SIMs, and the first indication information is determined by the network device based on the interference indication information.

10. The terminal device according to claim 8, wherein the processor is configured to:
adjust a transmit power of the interference source band based on the interference indication information.

11. The terminal device according to claim 8, wherein the transceiver is further configured to:
receive second indication information from the network device, wherein the second indication information is used to adjust a transmit power of the interference source band, and the second indication information is determined by the network device based on the interference indication information; or
receive a transmission resource configuration from the network device, wherein the transmission resource configuration is used to configure a transmission resource for at least one SIM in the at least two SIMs, and the transmission resource configuration is acquired by the network device via a configuration in a time-division multiplexing (TDM) mode based on the interference indication information.

12. A network device, comprising: a processor and a transceiver communicably connected to the processor:
wherein the transceiver is configured to receive terminal capability information for a first band combination from a terminal device, wherein the terminal device comprises N subscriber identity modules (SIMs), N being greater than 1, and the first band combination comprises operating bands for simultaneous operation of at least two SIMs in the N SIMs.

13. The network device according to claim 12, wherein the at least two SIMs comprise a first SIM and a second SIM; and the first band combination comprises a first band and a second band, wherein the first band is used to indicate an operating band of the first SIM, and the second band is used to indicate an operating band of the second SIM; and
the transceiver is further configured to:
receive, from the terminal device, first capability information on the first band transmitted via the first SIM, and second capability information on the second band via the second SIM; or
receive, from the terminal device, first capability information on the first band and second capability information on the second band transmitted via the first SIM.

14. The network device according to claim 13, wherein the first band comprises at least one band, and the second band comprises at least one band; wherein
in a case where the first band comprises at least two bands, the first capability information comprises capability information corresponding to at least one band in the first band; and
in a case where the second band comprises at least two bands, the second capability information comprises capability information corresponding to at least one band in the second band.

15. The network device according to claim 12, wherein the transceiver is further configured to:
receive, upon initial access, the terminal capability information for the first band combination from the terminal device; or
receive radio resource control (RRC) user equipment (UE) assistance information from the terminal device, wherein the RRC UE assistance information comprises the terminal capability information for the first band combination.

16. The network device according to claim 12, wherein the transceiver is further configured to:
receive operating mode indication information from the terminal device, wherein the operating mode indication information comprises at least one of: an operating mode, the first band combination currently in operation, or an operating band corresponding to another SIM within the first band combination currently in operation; and
wherein the operating mode is used to indicate one of: a multi-SIM operating mode or a single-SIM operating mode; and the another SIM is a SIM in the at least two SIMs other than a SIM used to transmit the operating mode indication information.

17. The network device according to claim 12, wherein the terminal capability information comprises at least one of:
transmit power capability information;
interference indication information;
uplink and/or downlink multiple-input multiple-output (MIMO) capability information;
supported band information;
a number of carriers; or
a peak rate.

18. The network device according to claim 12, wherein the terminal capability information comprises at least one of:
transmit power capability information corresponding to at least one band within the first band combination; or
total transmit power capability information of the terminal device.

19. The network device according to claim 18, wherein the processor is configured to:
perform transmit power control and/or mobility management for the terminal device based on the transmit power capability information.

20. The network device according to claim 12, wherein the terminal capability information comprises at least one of following interference indication information: an interference scenario, an interference intensity, or an operating band corresponding to each SIM within the first band combination;
wherein the interference scenario comprises at least one of: an interference source band, an interfered band, or an interference type.
